(19) United States
(12) Patent Application Publication
(10) Pub. No.: US 2024/0259858 A1
(43) Pub. Date: Aug. 1, 2024

(54) BANDWIDTH PREDICTION DEVICE, BANDWIDTH PREDICTION METHOD, AND PROGRAM

(71) Applicant: NIPPON TELEGRAPH AND TELEPHONE CORPORATION, Tokyo (JP)

(72) Inventors: Yuki YAMADA, Tokyo (JP); Tomoya KOSUGI, Tokyo (JP); Erina TAKESHITA, Tokyo (JP); Akihiro MORITA, Tokyo (JP)

(73) Assignee: NIPPON TELEGRAPH AND TELEPHONE CORPORATION, Tokyo (JP)

(21) Appl. No.: 18/561,267

(22) PCT Filed: May 20, 2021
(86) PCT No.: PCT/JP2021/019124

§ 371 Date: Nov. 15, 2023

(51) Int. Cl. H04W 28/02; H04W 28/20; H04W 28/24

(52) U.S. Cl. CPC H04W 28/0263; H04W 28/0268; H04W 28/20; H04W 28/24

(57) ABSTRACT

A band estimation device (10) according to the present disclosure includes: a classification unit (11) that acquires traffic information regarding traffic from a communication device (20) and classifies the acquired traffic information for each service; and an estimation unit (14) that estimates a necessary band for each service on the basis of the traffic information for each service and contract band information regarding a contract band of each of a plurality of users.

### TECHNICAL FIELD

The present disclosure relates to a band estimation device, a band estimation method, and a program.

### BACKGROUND ART

When a communication network in which a plurality of lines is accommodated in a link between communication devices is designed, information of a band necessary for the link (hereinafter, referred to as “necessary band”) is necessary. The communication band of each line has an upper limit value of the band according to the contract of each line (hereinafter, referred to as a “contract band”), but the number of lines accommodated in the link and the contract band thereof change with time according to new addition, contract change, or deletion of the line. Therefore, in the design of the communication network, it is important to calculate the necessary band in consideration of contract band information that is information regarding the contract band of each line. A network designer estimates a necessary band and determines whether or not a new line can be accommodated (accommodation determination) on the basis of whether or not the necessary band exceeds the band of an existing facility. When the necessary band exceeds the band of the existing facility, it is necessary to expand the facility. Therefore, estimating the necessary band with high accuracy leads to suppression of facility cost.

As a method for estimating a necessary band, a method of performing band estimation on the basis of information regarding traffic of each line flowing through a link acquired from a communication device has been reported. For example, Patent Literature 1 describes a method of calculating a future necessary band from a fluctuation of a band of an existing line.

### CITATION LIST

### Patent Literature

Patent Literature 1: JP 2009-118274 A

### SUMMARY OF INVENTION

### Technical Problem

In a communication network to which devices of a large number of users are connected, traffic caused by various services such as mobile (moving image video, social networking service (SNS)), Internet of Things (IoT), and mobile objects is flowing, and in recent years, diversification is further progressing. In the method described in Patent Literature 1, traffic information is acquired and analyzed without distinguishing various services. However, collectively analyzing services having different elements such as a use band of communication, an increase/decrease tendency in the number of users, and fluctuations within a day and a week may cause a decrease in accuracy of estimation of the necessary band. As described above, there is room for improvement in the accuracy of estimating the necessary band.

An object of the present disclosure made in view of the above problems is to provide a band estimation device, a band estimation method, and a program capable of improving accuracy of estimation of a necessary band.

### Solution to Problem

In order to solve the above problem, a band estimation device according to the present disclosure is a band estimation device that estimates a band necessary for a link between communication devices that accommodates a line of a plurality of users and through which traffic caused by a plurality of services flows, the band estimation device including: a classification unit that acquires traffic information regarding the traffic from the communication device and classifies the acquired traffic information for each of the services; and an estimation unit that estimates a necessary band for each of the services on the basis of the traffic information for each of the services and contract band information regarding a contract band of each of the plurality of users.

Furthermore, in order to solve the above problem, a band estimation method according to the present disclosure is a band estimation method that estimates a band necessary for a link between communication devices that accommodates a line of a plurality of users and through which traffic caused by a plurality of services flows, the band estimation method including: acquiring traffic information regarding the traffic from the communication device and classifying the acquired traffic information for each of the services; and estimating a necessary band necessary for each of the services on the basis of the traffic information for each of the services and contract band information regarding a contract band of each of the plurality of users.

Furthermore, in order to solve the above problems, a program according to the present disclosure causes a computer to function as the band estimation device described above.

### Advantageous Effects of Invention

With the band estimation device, the band estimation method, and the program according to the present disclosure, it is possible to improve the accuracy of estimation of the necessary band.

### BRIEF DESCRIPTION OF DRAWINGS

FIG. 1 is a diagram illustrating a configuration example of a band estimation device according to a first embodiment of the present disclosure.

FIG. 2A is a diagram for describing estimation of a necessary band for each service by an estimation unit illustrated in FIG. 1.

FIG. 2B is a diagram for describing estimation of a necessary band for each service by the estimation unit illustrated in FIG. 1.

FIG. 2C is a diagram for describing estimation of a necessary band for each service by the estimation unit illustrated in FIG. 1.

FIG. 3 is a flowchart illustrating an example of operation of the band estimation device illustrated in FIG. 1.

FIG. 4 is a diagram illustrating a configuration example of a band estimation device according to a second embodiment of the present disclosure.

FIG. 5 is a diagram illustrating an example of learning data input to a learning unit illustrated in FIG. 4.

FIG. 6 is a diagram illustrating an example of an estimation result of an estimation unit illustrated in FIG. 4.

FIG. 7 is a diagram illustrating a configuration example of a band estimation device according to a third embodiment of the present disclosure.

FIG. 8 is a diagram for describing extraction of periodicity of traffic by a periodicity extraction unit illustrated in FIG. 7.

FIG. 9 is a diagram illustrating an example of learning data input to a learning unit illustrated in FIG. 7.

FIG. 10 is a diagram illustrating a configuration example of a band estimation device according to a fourth embodiment of the present disclosure.

FIG. 11 is a diagram for describing determination of presence or absence of a feature of periodicity by a feature determination unit illustrated in FIG. 10.

FIG. 12 is a diagram illustrating a configuration example of the band estimation device according to the fourth embodiment of the present disclosure.

FIG. 13 is a diagram illustrating an example of a hardware configuration of the band estimation device illustrated in FIG. 1.

### DESCRIPTION OF EMBODIMENTS

Hereinafter, embodiments of the present disclosure will be described with reference to the drawings.

### First Embodiment

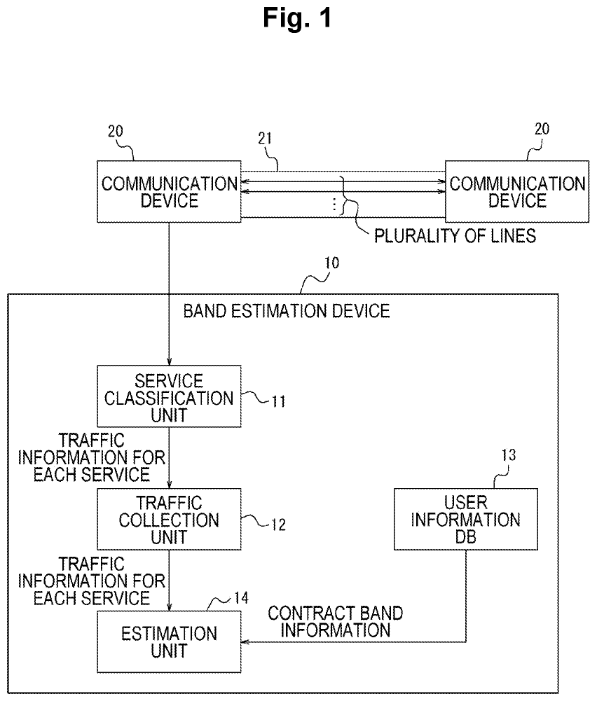

FIG. 1 is a diagram illustrating a configuration example of a band estimation device 10 according to a first embodiment of the present disclosure. The band estimation device 10 according to the present disclosure accommodates lines of a plurality of users and estimates a necessary band of a link 21 between communication devices 20 through which traffic caused by a plurality of services flows.

As illustrated in FIG. 1, the band estimation device 10 according to the present embodiment includes a service classification unit 11, a traffic collection unit 12, a user information database (DB) 13, and an estimation unit 14.

The service classification unit 11 acquires, from the communication device 20, traffic information that is information regarding traffic (band) flowing through the link 21. The service classification unit 11 classifies the acquired traffic information for each service. That is, the service classification unit 11 classifies the traffic information of the traffic caused by the service for each service. For example, at the time of network design, by classifying services in advance by tag, virtual local area network (V-LAN), priority, segment ID (SID), and the like, the service classification unit 11 can classify traffic information for each service on the basis of information of this classification. Furthermore, the service classification unit 11 can classify the traffic information for each service, for example, by reading the content of a packet and sensing the service content by a deep packet inspection (DPI) technology. The service classification unit 11 outputs the traffic information classified for each service to the traffic collection unit 12.

The traffic collection unit 12 collects the traffic information for each service output from the service classification unit 11 and outputs the collected traffic information to the estimation unit 14.

The user information DB 13 is a database that stores information (hereinafter, referred to as “contract band information”) regarding a contract band that is an upper limit value of a band according to a contract of a line of each user. The user information DB 13 outputs the stored contract band information to the estimation unit 14. The estimation unit 14 estimates the necessary band for each service on the basis of the traffic information for each service output from the traffic collection unit 12 and the contract band information output from the user information DB 13.

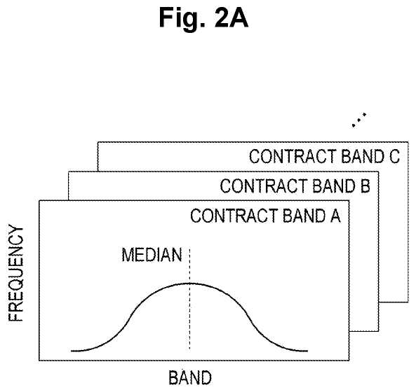

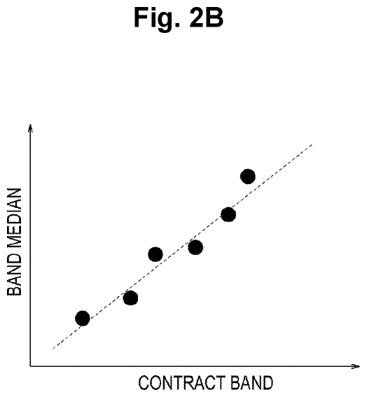

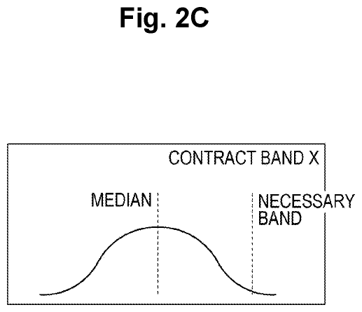

Estimation of the necessary band for each service by the estimation unit 14 will be described with reference to FIGS. 2A to 2C. The estimation unit 14 performs processing described with reference to FIGS. 2A to 2C for each service.

The estimation unit 14 extracts, for each contract band, traffic information of traffic caused by a service that is a target for estimation of the necessary band (hereinafter, referred to as a “target service”). That is, the estimation unit 14 extracts the traffic information of traffic caused by the target service for each contract band (Contract Band A, Contract Band B, Contract Band C, . . . ). Next, as illustrated in FIG. 2A, the estimation unit 14 evaluates a distribution of bands (past bands) indicated in the traffic information extracted for each contract band, and obtains a median and a variance of the past bands. As the distribution function of the band, for example, a normal distribution can be used, but the distribution function is not limited thereto.

Next, as illustrated in FIG. 2B, the estimation unit 14 approximates the relationship between the median of the past bands and the contract band by an arbitrary function. As the approximation of the relationship between the median of the bands and the contract band, for example, linear approximation can be used, but it is not limited thereto.

Next, as illustrated in FIG. 2C, the estimation unit 14 calculates the median of future bands in a certain contract band X on the basis of the relationship between the median of the bands and the contract band described above and future contract band information prepared in advance. Finally, the estimation unit 14 obtains the distribution of the traffic (band) caused by the service for which estimation is performed on the basis of the variance of the past bands and the median of the future bands, and derives the necessary band. For example, in a case where the service agreement level (SLA) of the network is 99%, the estimation unit 14 may set the necessary band so that 99% of the obtained distribution can be covered. Furthermore, the estimation unit 14 may derive the necessary band by adding a buffer in consideration of bypass traffic or the like at the time of occurrence of a failure in the communication network. By estimating the necessary band for each service, the necessary band of the link 21 can also be estimated.

Next, an operation of the band estimation device 10 according to the present embodiment will be described.

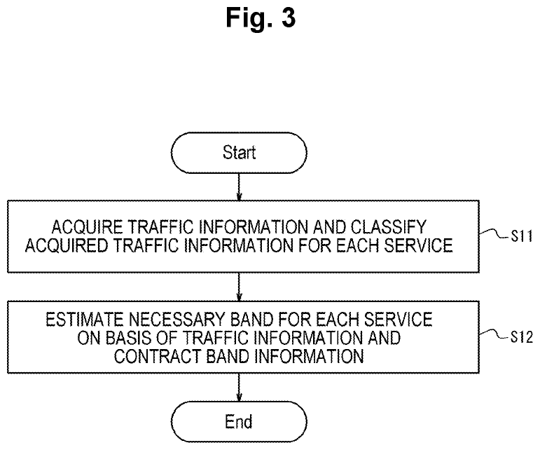

FIG. 3 is a flowchart illustrating an example of the operation of the band estimation device 10 according to the present embodiment, and is a diagram for describing a band estimation method by the band estimation device 10.

The service classification unit 11 acquires the traffic information regarding the traffic flowing through the link 21 from the communication device 20, and classifies the acquired traffic information for each service (step S11).

The estimation unit 14 estimates the necessary band necessary for each service on the basis of the traffic information for each service and the contract band information stored in the user information DB 13 (step S12).

As described above, the band estimation device 10 according to the present embodiment includes the service classification unit 11 and the estimation unit 14. The service classification unit 11 acquires the traffic information regarding traffic flowing through the link 21 from the communication device 20, and classifies the acquired traffic information for each service. The estimation unit 14 estimates the necessary band necessary for each service on the basis of the traffic information for each service and the contract band information regarding the contract band of each of a plurality of users.

By classifying the traffic information for each service and estimating the necessary band for each service, it is possible to estimate the necessary band after classifying various services having different band increase and decrease tendencies. Therefore, it is possible to improve the accuracy of the estimation of the necessary band in the communication network in which the plurality of lines is accommodated in the link 21 and the traffic of the plurality of services flows. Furthermore, since it is possible to perform accommodation determination for each service by estimating the necessary band for each service, it is possible to determine the necessity of facility expansion for each service and to reduce the facility cost. Furthermore, since high estimation accuracy can be obtained even with collected data (traffic information) in a short period, the amount of data that needs to be recorded by the traffic collection unit 12 can be suppressed, and the facility cost can be reduced.

### Second Embodiment

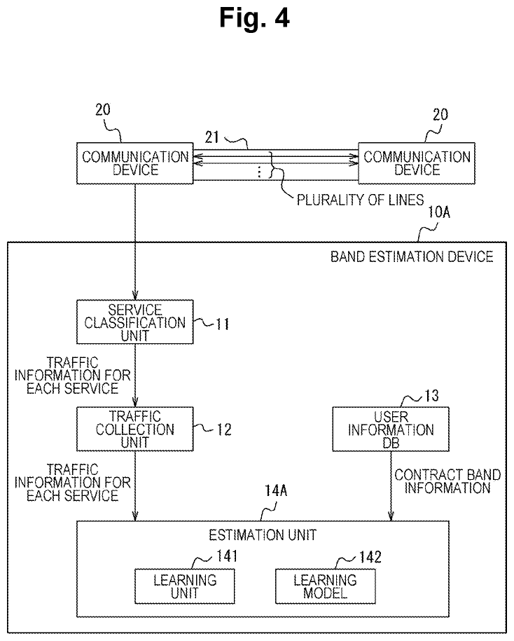

FIG. 4 is a diagram illustrating a configuration example of a band estimation device 10A according to the second embodiment of the present disclosure. In FIG. 4, configurations similar to those in FIG. 1 are denoted by the same reference signs, and description thereof will be omitted.

As illustrated in FIG. 4, the band estimation device 10A according to the present embodiment includes a service classification unit 11, a traffic collection unit 12, a user information DB 13, and an estimation unit 14A. The band estimation device 10A according to the present embodiment is different from the band estimation device 10 according to the first embodiment in that the estimation unit 14 is changed to the estimation unit 14A.

The estimation unit 14A includes a learning unit 141.

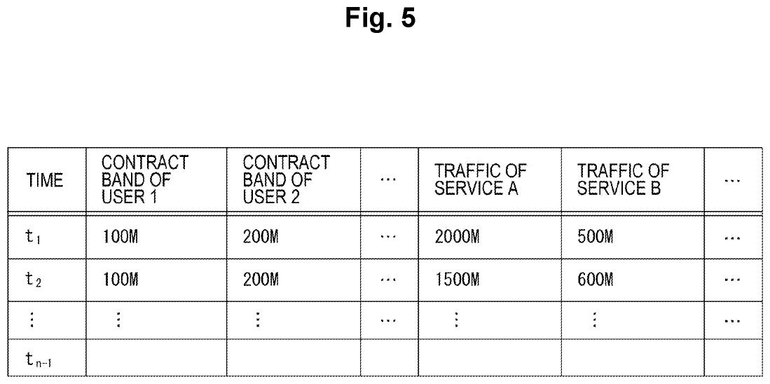

The learning unit 141 creates a learning model 142 by machine learning using past contract band information of each of the plurality of users stored in the user information DB 13 and past traffic information of each of the plurality of services output from the traffic collection unit 12 as learning data. Specifically, as illustrated in FIG. 5, the contract band information of each user and the traffic information of each service at each of past times t₁ to tₙ₋₁ are input to the learning unit 141 as learning data. The learning unit 141 optimizes parameters of the learning model 142 on the basis of the input learning data. That is, the learning unit 141 extracts a correlation between the contract band information of each user and the traffic information of each service input as the learning data.

The estimation unit 14A inputs the contract band information (current and future contract band information) of each of the plurality of users at each of the times tₙ, tₙ₊₁, . . . stored in the user information DB to the learning model 142 created by the learning unit 141, and estimates the necessary band necessary for each service.

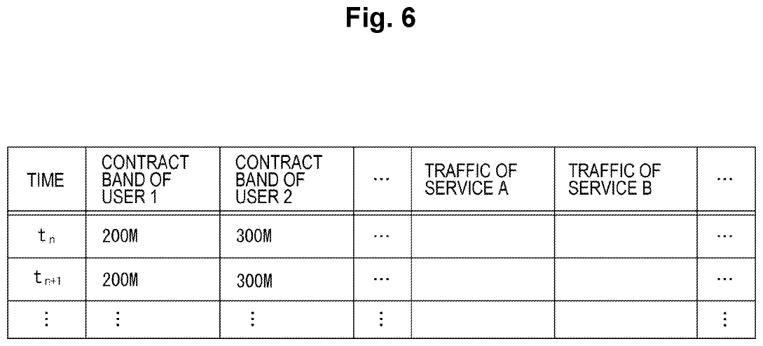

Specifically, as illustrated in FIG. 6, the estimation unit 14A estimates the necessary band of each of the plurality of services at each of the times tₙ, tₙ₊₁, . . . . The estimation unit 14A may compare the estimated necessary band with an upper limit band allowed by the communication device 20 and perform accommodation determination to determine whether or not the communication device 20 can accommodate a line.

As described above, in the present embodiment, the band estimation device 10A includes the estimation unit 14A. The estimation unit 14A creates the learning model 142 by machine learning using past contract band information of each of the plurality of users and past traffic information of each of the plurality of services as learning data. Then, the estimation unit 14A inputs the contract band information of each of the plurality of users to the learning model 142, and estimates the necessary band necessary for each service.

In the band estimation device 10 according to the first embodiment, since the necessary band is estimated from the relationship between the contract band of the user and the traffic, the accuracy of estimation decreases in a case where the band utilization rate is different for each user. In order to solve this, it is necessary to consider the band utilization rate for each user as a parameter, but analysis of enormous data is necessary. By using machine learning as in the present embodiment, analysis can be performed in a short time, and the accuracy of estimation of the necessary band can be further improved as compared with the first embodiment.

Note that, in the present embodiment, an example in which the contract band information of each of the plurality of users and the traffic information of each of the plurality of services are learned as the learning data has been described, but it is not limited thereto. The time information, the transmission destination information, the transmission source information, the V-LAN, the tag, the packet length for each priority, the number of packets, and the like may be further included in the learning data.

Furthermore, in FIG. 6, an example is illustrated in which the estimation unit 14A outputs a numerical value of the necessary band for each service as an estimation result, but it is not limited thereto, and the estimation unit 14A may output a set of the numerical value of the necessary band and the probability of taking the value as the estimation result.

### Third Embodiment

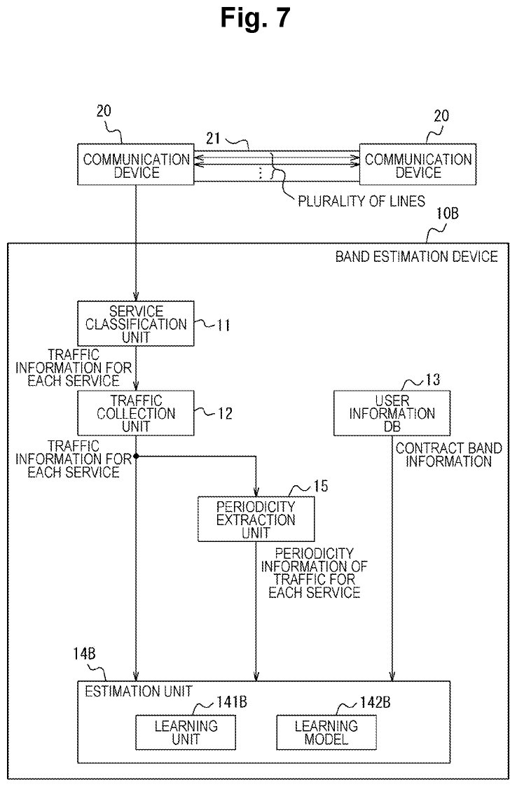

FIG. 7 is a diagram illustrating a configuration example of a band estimation device 10B according to the third embodiment of the present disclosure. In FIG. 7, configurations similar to those in FIG. 4 are denoted by the same reference signs, and description thereof will be omitted.

As illustrated in FIG. 7, the band estimation device 10B according to the present embodiment includes a service classification unit 11, a traffic collection unit 12, a user information DB 13, an estimation unit 14B, and a periodicity extraction unit 15. The band estimation device 10B according to the present embodiment is different from the band estimation device 10A according to the second embodiment in that the estimation unit 14A is changed to the estimation unit 14B and the periodicity extraction unit 15 is added.

The periodicity extraction unit 15 extracts the periodicity of the traffic caused by each of a plurality of services on the basis of the traffic information for each service output from the traffic collection unit 12.

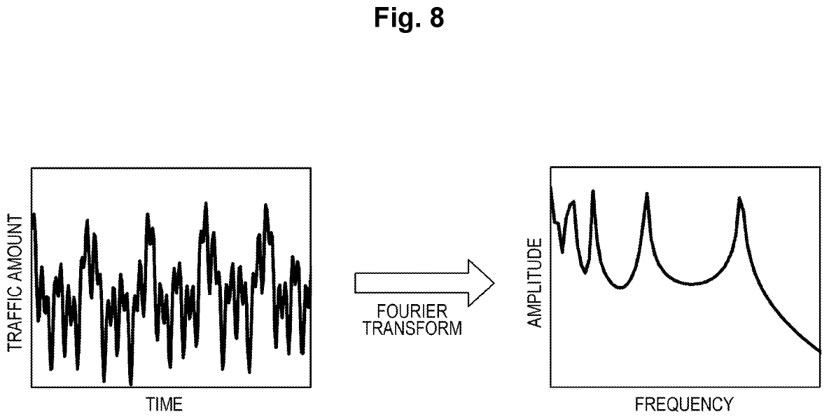

FIG. 8 is a diagram for describing extraction of periodicity of traffic by the periodicity extraction unit 15. As illustrated in FIG. 8, a time-series change in traffic amount is obtained from the traffic information. The periodicity extraction unit 15 performs frequency analysis such as Fourier transform, discrete Fourier transform, and wavelet transform on a time-series change in the traffic amount to extract information (periodicity information) regarding the periodicity of the traffic. FIG. 8 illustrates an example in which the time-series change in the traffic amount is transformed into amplitude (corresponding to the magnitude of periodicity) at each frequency (corresponding to the reciprocal of the period) by Fourier transform. The periodicity extraction unit 15 outputs the extracted periodicity information of the traffic for each service to the estimation unit 14B.

The estimation unit 14B is different from the estimation unit 14A in that the learning unit 141 is changed to a learning unit 141B.

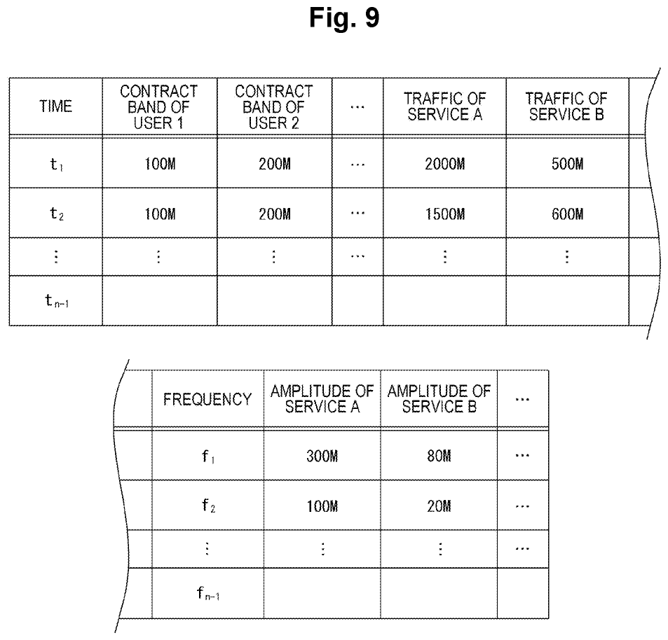

The learning unit 141B creates a learning model 142B by machine learning using past contract band information of each of the plurality of users stored in the user information DB 13, past traffic information of each of the plurality of services output from the traffic collection unit 12, and the periodicity of the traffic of each of the plurality of services extracted by the periodicity extraction unit 15 as learning data. Specifically, as illustrated in FIG. 9, the contract band information of each user, the traffic information of each service, and the periodicity information (frequency and amplitude indicating periodicity of traffic) of traffic of each service at each of past times t₁ to tₙ₋₁ are input to the learning unit 141B as learning data. The learning unit 141B optimizes parameters of the learning model 142B on the basis of the input learning data. That is, the learning unit 141B extracts a correlation between the contract band information of each user, the traffic information of each service, and the periodicity of traffic of each service input as the learning data.

The estimation unit 14B inputs the contract band information (current and future contract band information) of each of the plurality of users at each of the times tₙ, tₙ₊₁, . . . stored in the user information DB to the learning model 142B created by the learning unit 141B, and estimates the necessary band necessary for each service.

As described above, in the present embodiment, the band estimation device 10B includes the periodicity extraction unit 15 and the estimation unit 14B. The periodicity extraction unit 15 extracts the periodicity of the traffic caused by each of the plurality of services on the basis of the traffic information of each of the plurality of services. The estimation unit 14B includes the learning unit 141B. The learning unit 141B creates the learning model 142B by machine learning using the contract band information of each of the plurality of users, the traffic information of each of the plurality of services, and the periodicity extracted by the periodicity extraction unit 15 as learning data.

By adding the periodicity of the traffic of each of the plurality of services to the learning data, the information regarding the time dependency of the traffic different for each service can also be learned, so that it is possible to further improve the accuracy of the estimation of the necessary band in multi-services. Furthermore, in a new service, it is conceivable that the periodicity of the traffic changes from testing to normal operation. In this case, by extracting the periodicity of the traffic, it is possible to perform learning in consideration of the information regarding the operation form of the service.

### Fourth Embodiment

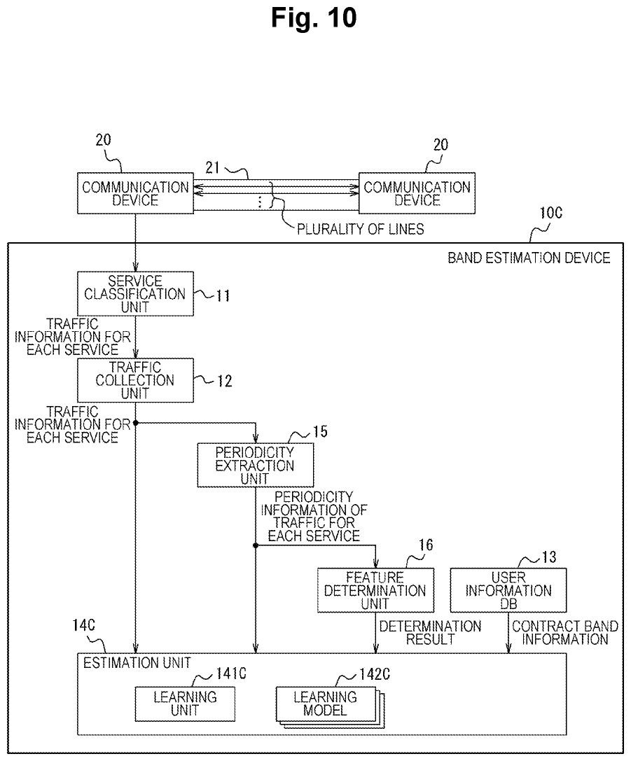

FIG. 10 is a diagram illustrating a configuration example of a band estimation device 10C according to the fourth embodiment of the present disclosure. In FIG. 10, configurations similar to those in FIG. 7 are denoted by the same reference signs, and description thereof will be omitted.

As illustrated in FIG. 10, the band estimation device 10C according to the present embodiment includes a service classification unit 11, a traffic collection unit 12, a user information DB 13, an estimation unit 14C, a periodicity extraction unit 15, and a feature determination unit 16. The band estimation device 10C according to the present embodiment is different from the band estimation device 10B according to the third embodiment in that the estimation unit 14B is changed to the estimation unit 14C and the feature determination unit 16 is added.

The feature determination unit 16 determines the presence or absence of the feature of the periodicity or the feature of the periodicity of the traffic for each service extracted by the periodicity extraction unit 15. For example, the feature determination unit 16 determines whether the traffic of the service changes at a characteristic cycle, has a magnitude of a peak at a characteristic frequency, or is a steady traffic or random traffic.

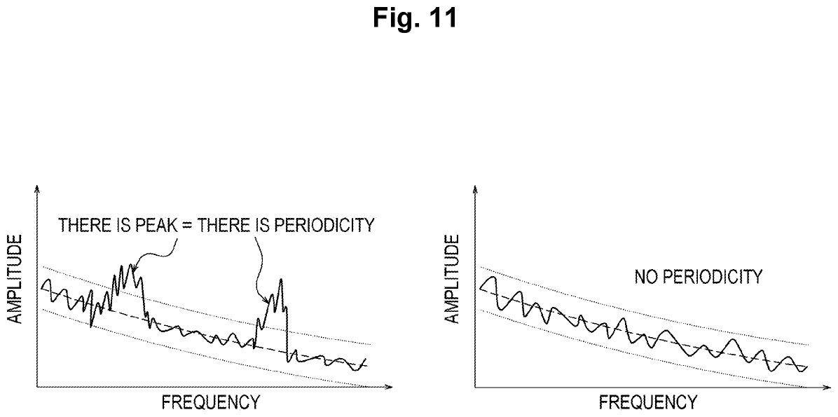

FIG. 11 is a diagram illustrating an example of determination of a feature of periodicity by the feature determination unit 16.

As described above, the time-series change in traffic is transformed into a spectrum of frequency and amplitude by Fourier transform as illustrated in FIG. 11. The feature determination unit 16 fits the spectrum of the frequency and the amplitude by an arbitrary function, and determines that there is periodicity when there is a peak deviating from the fitting curve at an arbitrary proportion, and determines that there is no periodicity when there is no peak. Furthermore, for example, the feature determination unit 16 may perform similar analysis on partial coefficients of the spectrum of the frequency and the amplitude.

Referring back to FIG. 10, the feature determination unit 16 outputs the determination result to the estimation unit 14C.

The estimation unit 14C is different from the estimation unit 14B in that the learning unit 141B is changed to a learning unit 141C.

The learning unit 141C creates a learning model 142C by machine learning using the traffic information for each service, the contract band information, and the periodicity information of the traffic for each service as learning data. Here, the learning unit 141C creates, for example, a plurality of learning models 142C having different parameters used for learning.

The estimation unit 14C determines the necessary band for each service by using the learning model 142C according to the feature of the periodicity determined by the feature determination unit 16 among the plurality of learning models 142C created by the learning unit 141C.

For example, when there is a time-series periodicity in the traffic (a correlation between time and traffic is large), it is necessary to apply a model suitable for handling a non-steady state. On the other hand, when there is no time-series periodicity in the traffic (when a correlation between time and traffic is small) (in the case of steady data or random data), it is necessary to apply a model suitable for handling a steady state, which has a smaller calculation processing load than a model suitable for handling a non-steady state. The estimation unit 14C selects the learning model 142C according to the feature of the traffic caused by the service on the basis of the determination result of the feature determination unit 16. As described above, by selecting the learning model 142C according to the feature of the traffic caused by the service, it is possible to further improve the estimation accuracy and reduce the calculation processing load. Furthermore, in the case of estimating the necessary band of a new service for which it is not clear what kind of learning model 142C should be used, by using the learning model 142C used for estimating the necessary band of another service having similar traffic periodicity, it is possible to improve the accuracy of estimating the necessary band even for the new service.

Note that, in the present embodiment, an example in which the learning model 142C to be used for estimation of the necessary band is selected from the plurality of learning models 142C on the basis of the result of determination of the feature determination unit 16 has been described, but it is not limited thereto. For example, in the band estimation device 10 illustrated in FIG. 1, in a case where a plurality of algorithms for estimating the necessary band is prepared, an algorithm to be used for estimating the necessary band may be selected from the plurality of prepared algorithms according to the feature of the traffic caused by the service.

### Fifth Embodiment

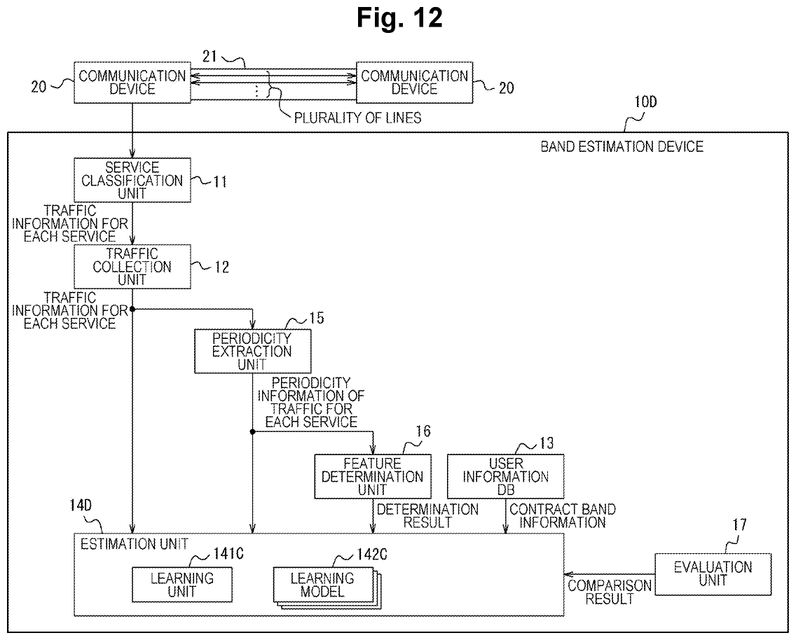

FIG. 12 is a diagram illustrating a configuration example of a band estimation device 10D according to a fifth embodiment of the present disclosure. In FIG. 12, configurations similar to those in FIG. 10 are denoted by the same reference signs, and description thereof will be omitted.

As illustrated in FIG. 12, the band estimation device 10D according to the present embodiment includes a service classification unit 11, a traffic collection unit 12, a user information DB 13, an estimation unit 14D, a periodicity extraction unit 15, a feature determination unit 16, and an evaluation unit 17. The band estimation device 10D according to the present embodiment is different from the band estimation device 10C illustrated in FIG. 10 in that the estimation unit 14C is changed to the estimation unit 14D and the evaluation unit 17 is added.

The evaluation unit 17 compares the necessary band of the service estimated by the estimation unit 14D with the band actually necessary for the service, and outputs a result of the comparison to the estimation unit 14D. The evaluation unit 17 outputs, for example, a difference between the necessary band of the service estimated by the estimation unit 14 and the actually necessary band to the estimation unit 14D as a comparison result.

Similarly to the estimation unit 14C, the estimation unit 14D selects a learning model C142C according to the determination result of the feature of the periodicity of the traffic caused by the service from the plurality of learning models 142C, and estimates the necessary band of the service. Then, the estimation unit 14D changes the parameter of the learning model 142C used for estimation of the necessary band according to the result of comparison by the evaluation unit 17. For example, in a case where an error of an arbitrary proportion or more occurs between the necessary band estimated using a first learning model 142C-1 and the actually necessary band, the estimation unit 14D estimates the necessary band again using a second learning model 142C-2. Then, the estimation unit 14D uses, for example, the learning model 142 having a small error from the actually necessary band among the necessary band estimated by the first learning model 142C-1 and the necessary band estimated by the second learning model 142C-2 as a model for estimating the necessary band.

As described above, in the present embodiment, it is possible to further improve the estimation of the necessary band by evaluating the estimation result of the necessary band by the estimation unit 14D by the evaluation unit 17. In particular, a remarkable effect is expected when estimating the necessary band of a new service for which it is not clear what kind of learning model 142C should be used.

Note that, in the present embodiment, an example in which the parameter of the learning model 142C used for estimation of the necessary band is changed according to the result of comparison by the evaluation unit 17 has been described, but it is not limited thereto. For example, in the band estimation device 10 illustrated in FIG. 1, the parameter of the algorithm for estimating the necessary band may be changed according to the result of comparison by the evaluation unit 17. Furthermore, the parameter regarding determination by the feature determination unit 16 may be changed according to the result of comparison by the evaluation unit 17.

Next, a hardware configuration of the band estimation device 10 according to the present disclosure will be described. Note that the band estimation device 10 will be described below as an example, but the same applies to the band estimation devices 10A, 10B, 10C, and 10D.

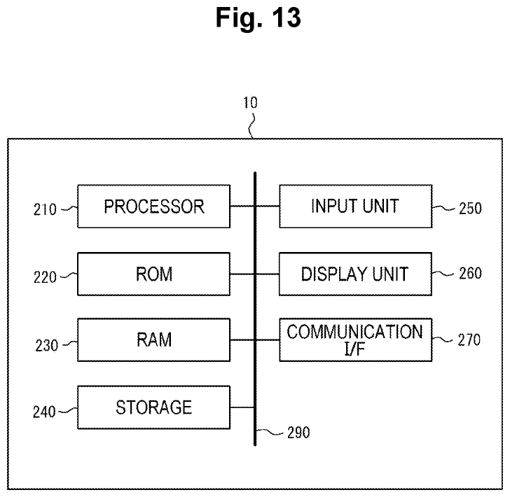

FIG. 13 is a diagram illustrating an example of a hardware configuration of the band estimation device 10 according to an embodiment of the present disclosure. FIG. 13 illustrates an example of a hardware configuration of the band estimation device 10 in a case where the band estimation device 10 is configured by a computer capable of executing a program command. Here, the computer may be a general-purpose computer, a dedicated computer, a workstation, a personal computer (PC), an electronic note pad, or the like. The program command may be a program code, code segment, or the like for executing a necessary task.

As illustrated in FIG. 13, the band estimation device 10 includes a processor 210, read only memory (ROM) 220, random access memory (RAM) 230, a storage 240, an input unit 250, a display unit 260, and a communication interface (I/F) 270. The configurations are communicably connected to each other via a bus 290. Specifically, the processor 210 is a central processing unit (CPU), a micro processing unit (MPU), a graphics processing unit (GPU), a digital signal processor (DSP), a system on a chip (SoC), or the like and may be configured by the same or different types of a plurality of processors.

The processor 210 is a controller that executes control of the components and various types of arithmetic processing. That is, the processor 210 reads a program from the ROM 220 or the storage 240 and executes the program using the RAM 230 as a working area. The processor 210 performs control of each of the above configurations and various types of arithmetic processing according to the program stored in the ROM 220 or the storage 240. In the present embodiment, the ROM 220 or the storage 240 stores the program for causing a computer to function as the band estimation device 10 according to the present disclosure. By reading and executing the program by the processor 210, each configuration of the band estimation device 10, that is, the service classification unit 11, the traffic collection unit 12, and the estimation unit 14 are realized.

The program may be provided in a form in which the program is stored in a non-transitory storage medium, such as a compact disk read only memory (CD-ROM), a digital versatile disk read only memory (DVD-ROM), and a universal serial bus (USB) memory. Furthermore, the program may be downloaded from an external device via a network.

The ROM 220 stores various programs and various types of data (for example, contract band information). The RAM 230 as a work area temporarily stores programs or data. The storage 240 includes a hard disk drive (HDD) or a solid state drive (SSD) and stores various programs including an operating system and various types of data. The input unit 250 includes a pointing device such as a mouse and a keyboard and is used to perform various inputs.

The display unit 260 is, for example, a liquid crystal display, and displays various types of information. A touch panel system may be adopted so that the display unit 260 can function as the input unit 250.

A communication interface 270 is an interface for communicating with an external device such as the communication device 20, and for example, a standard such as Ethernet (registered trademark), FDDI, and Wi-Fi (registered trademark) is used.

A computer can be suitably used to function as each unit of the band estimation device 10 described above. Such a computer can be realized by storing a program in which processing contents for realizing the function of each unit of the band estimation device 10 are described in a storage unit of the computer and reading and executing the program by a processor of the computer. That is, the program can cause the computer to function as the band estimation device 10 described above. Furthermore, the program can be recorded in a non-transitory recording medium. Furthermore, the program can also be provided via a network.

Regarding the above embodiments, the following supplementary notes are further disclosed.

### (Supplement 1)

A band estimation device that estimates a band necessary for a link between communication devices that accommodates a line of a plurality of users and through which traffic caused by a plurality of services flows, the band estimation device including:
a classification unit that acquires traffic information regarding the traffic from the communication device and classifies the acquired traffic information for each of the services; and
an estimation unit that estimates a necessary band for each of the services on the basis of the traffic information for each of the services and contract band information regarding a contract band of each of the plurality of users.

### (Supplement 2)

The band estimation device according to supplement 1, in which
the estimation unit
creates a learning model by machine learning using contract band information of each of the plurality of users and traffic information of each of the plurality of services as learning data, and
inputs contract band information of each of the plurality of users to the learning model to estimate a necessary band necessary for each of the services.

### (Supplement 3)

The band estimation device according to supplement 2, further including:
a periodicity extraction unit that extracts periodicity of traffic caused by each of the plurality of services on the basis of traffic information of each of the plurality of services,
in which
the estimation unit creates the learning model by machine learning using contract band information of each of the plurality of users, traffic information of each of the plurality of services, and periodicity extracted by the periodicity extraction unit as learning data.

### (Supplement 4)

The band estimation device according to supplement 3, further including:
a feature determination unit that determines a feature of the periodicity extracted by the periodicity extraction unit,
in which
the estimation unit creates a plurality of learning models having different parameters regarding learning, and estimates the necessary band using a learning model corresponding to the feature of the periodicity determined by the feature determination unit among the plurality of learning models.

### (Supplement 5)

The band estimation device according to supplement 1, further including:
a periodicity extraction unit that extracts periodicity of traffic caused by each of the plurality of services on the basis of past traffic information of each of the plurality of services; and
a feature determination unit that determines a feature of the periodicity extracted by the periodicity extraction unit,
in which
the estimation unit estimates the necessary band by using an algorithm according to a feature of the periodicity determined by the feature determination unit among a plurality of algorithms for estimating the necessary band.

### (Supplement 6)

The band estimation device according to supplement claim 4, further including:
an evaluation unit that compares a necessary band of a service estimated by the estimation unit with an actually necessary band in the service,
in which
the estimation unit changes a parameter of an algorithm or a model used for estimation of the necessary band according to a result of comparison by the evaluation unit.

### (Supplement 7)

A band estimation method that estimates a band necessary for a link between communication devices that accommodates a line of a plurality of users and through which traffic caused by a plurality of services flows, the band estimation method including:
acquiring traffic information regarding the traffic from the communication device and classifying the acquired traffic information for each of the services; and
estimating a necessary band necessary for each of the services on the basis of the traffic information for each of the services and contract band information regarding a contract band of each of the plurality of users.

### (Supplement 8)

A non-transitory storage medium storing a program that is executable by a computer, the non-transitory storage medium storing a program that causes the computer to function as the control device according to Supplement 1.

Although the above-described embodiments have been described as representative examples, it is apparent to those skilled in the art that many modifications and substitutions can be made within the spirit and scope of the present disclosure. Therefore, it should not be understood that the present invention is limited by the above-described embodiments, and various modifications or changes can be made without departing from the scope of the claims. For example, a plurality of configuration blocks illustrated in the configuration diagrams of the embodiments can be combined into one, or one configuration block can be divided.

### REFERENCE SIGNS LIST

10, 10A, 10B, 10C Band estimation device
11 Service classification unit
12 Traffic collection unit
13 User information DB
14, 14A, 14B, 14C, 14D Estimation unit
141, 141B, 141C Learning unit
142, 142B, 142C Learning model
15 Periodicity extraction unit
16 Feature determination unit
17 Evaluation unit
20 Communication device
21 Link

1. A band estimation device comprising a processor configured to execute operations comprising:
acquiring traffic information regarding traffic from a communication device;
classifying the acquired traffic information for each of a plurality of services; and
estimating a band of a link for each of the services on a basis of the traffic information for each of the services and predetermined maximum band information regarding a predetermined maximum band of each of the plurality of users, wherein the link connects communication devices of a plurality of users, and the link accommodates traffic flows caused by the plurality of services.

2. The band estimation device according to claim 1, wherein
the estimating further comprises:
creating a learning model by machine learning using the predetermined maximum band information of each of the plurality of users and traffic information of each of the plurality of services as learning data, and
inputting the predetermined maximum band information of each of the plurality of users to the learning model to estimate a band of a link for each of the services.

3. The band estimation device according to claim 2, the processor further configured to execute operations comprising:
extracting periodicity of traffic caused by each of the plurality of services on a basis of traffic information of each of the plurality of services,
wherein
the estimating further comprises creating the learning model by machine learning using, as learning data, the predetermined maximum band information of each of the plurality of users, the traffic information of each of the plurality of services, and the periodicity.

4. The band estimation device according to claim 3, the processor further configured to execute operations comprising:
determining a feature of the periodicity,
wherein the estimating further comprises:
creating a plurality of learning models having different parameters regarding learning, and
estimating the band of the link using a learning model corresponding to the feature of the periodicity determined by the feature determination unit among the plurality of learning models.

5. The band estimation device according to claim 1, the processor further configured to execute operations comprising:
extracting periodicity of traffic caused by each service of the plurality of services on a basis of past traffic information of each of the plurality of services; and
determining a feature of the periodicity, wherein the estimating further comprises estimating the band of the link by using an algorithm according to the feature of the periodicity among a plurality of algorithms for estimating the band of the link.

6. The band estimation device according to claim 4, further comprising:
comparing the estimated band of the link of a service with an actually necessary band of the link in the service, wherein the estimating further comprises changing a parameter of an algorithm or a model used for estimation of the band of the link according to a result of comparison.

7. A method for estimating a band of a link, comprising:
acquiring traffic information regarding the traffic from a communication device;
classifying the acquired traffic information for each of the services; and
estimating a band of the link for each of the services on a basis of the traffic information for each of the services and predetermined maximum band information regarding a predetermined maximum band of each of the plurality of users, wherein the link connects communication devices of a plurality of users, and the link accommodates traffic flows caused by the plurality of services.

8. A computer-readable non-transitory recording medium storing computer-executable program instructions that when executed by a processor cause a computer to execute operations comprising:
acquiring traffic information regarding the traffic from a communication device;
classifying the acquired traffic information for each of a plurality of services; and
estimating a band of a link for each of the services on a basis of the traffic information for each of the services and predetermined maximum band information regarding a predetermined maximum band of each of the plurality of users, wherein the link connects communication devices of a plurality of users, and the link accommodates traffic flows caused by the plurality of services.

9. The band estimation device according to claim 5, further comprising:
comparing the estimated band of the link of a service with an actually necessary band of the link in the service, wherein the estimating further comprises changing a parameter of an algorithm or a model used for estimation of the band of the link according to a result of comparison.

10. The method according to claim 7, wherein
the estimating further comprises creating a learning model by machine learning using the predetermined maximum band information of each of the plurality of users and traffic information of each of the plurality of services as learning data, and
inputting the predetermined maximum band information of each of the plurality of users to the learning model to estimate a band of a link for each of the services.

11. The method according to claim 10, further comprising:
extracting periodicity of traffic caused by each of the plurality of services on a basis of traffic information of each of the plurality of services, wherein the estimating further comprises creating the learning model by machine learning using, as learning data, the predetermined maximum band information of each of the plurality of users, the traffic information of each of the plurality of services, and the periodicity.

12. The method according to claim 11, further comprising:
determining a feature of the periodicity,
wherein the estimating further comprises:
creating a plurality of learning models having different parameters regarding learning, and
estimating the band of the link using a learning model corresponding to the feature of the periodicity determined by the feature determination unit among the plurality of learning models.

13. The method according to claim 7, further comprising:
extracting periodicity of traffic caused by each of the plurality of services on a basis of past traffic information of each of the plurality of services; and
determining a feature of the periodicity, wherein the estimating further comprises estimating the band by using an algorithm according to the feature of the periodicity among a plurality of algorithms for estimating the band.

14. The method according to claim 12, further comprising:
comparing a band of a service with an actually necessary band in the service, wherein the estimating further comprises changing a parameter of an algorithm or a model used for estimation of the band of the link according to a result of comparison.

15. The method according to claim 13, further comprising:
comparing a band of a service with an actually necessary band in the service, wherein the estimating further comprises changing a parameter of an algorithm or a model used for estimation of the band of the link according to a result of comparison.

16. The computer-readable non-transitory recording medium according to claim 8, wherein
the estimating further comprises creating a learning model by machine learning using the predetermined maximum band information of each of the plurality of users and traffic information of each of the plurality of services as learning data, and
inputting the predetermined maximum band information of each of the plurality of users to the learning model to estimate a band of a link for each of the services.

17. The computer-readable non-transitory recording medium according to claim 16, the computer-executable program instructions when executed further causing the computer to execute operations comprising:
extracting periodicity of traffic caused by each of the plurality of services on a basis of traffic information of each of the plurality of services, wherein the estimating further comprises creating the learning model by machine learning using, as learning data, the predetermined maximum band information of each of the plurality of users, the traffic information of each of the plurality of services, and the periodicity.

18. The computer-readable non-transitory recording medium according to claim 17, the computer-executable program instructions when executed further causing the computer to execute operations comprising:
determining a feature of the periodicity,
wherein the estimating further comprises:
creating a plurality of learning models having different parameters regarding learning, and
estimating the band of the link using a learning model corresponding to the feature of the periodicity determined by the feature determination unit among the plurality of learning models.

19. The computer-readable non-transitory recording medium according to claim 8, the computer-executable program instructions when executed further causing the computer to execute operations comprising:
extracting periodicity of traffic caused by each of the plurality of services on a basis of past traffic information of each of the plurality of services; and
determining a feature of the periodicity, wherein the estimating further comprises estimating the band by using an algorithm according to the feature of the periodicity among a plurality of algorithms for estimating the band.

20. The computer-readable non-transitory recording medium according to claim 18, the computer-executable program instructions when executed further causing the computer to execute operations comprising:
comparing a band of a service with an actually necessary band in the service, wherein the estimating further comprises changing a parameter of an algorithm or a model used for estimation of the band of the link according to a result of comparison.
